(19) United States
(12) Patent Application Publication
(10) Pub. No.: US 2026/0147701 A1
(43) Pub. Date: May 28, 2026

(54) METHOD AND SYSTEM FOR DEFECT DETERMINATION IN GENERATIVE ARTIFICIAL INTELLIGENCE-BASED SEARCH SYSTEM

(71) Applicant: NAVER CORPORATION, Seongnam-si (KR)

(72) Inventors: Jae Hun SHIN, Seongnam-si (KR); Se Jong KIM, Seongnam-si (KR); Sang Jin SIM, Seongnam-si (KR); Hyoung Dong HAN, Seongnam-si (KR); Seung Hak YU, Seongnam-si (KR); Young-Bum KIM, Seongnam-si (KR)

(73) Assignee: NAVER CORPORATION, Seongnam-si (KR)

(21) Appl. No.: 19/397,373

(22) Filed: Nov. 21, 2025

(30) Foreign Application Priority Data
Nov. 22, 2024 (KR) 10-2024-0168416

(51) Int. Cl. G06F 11/3668

(52) U.S. Cl. CPC G06F 11/3692

(57) ABSTRACT

A method for defect determination in a generative AI-based search system includes collecting a user query input to the generative AI-based search system, collecting an answer from the AI-based search system corresponding to the user query, collecting log data for each of a plurality of operation processes of the AI-based search system processed to output the answer to the user query, determining whether each of the plurality of operation processes is defective based on at least some of the user query, the answer, or the respective log data, and determining whether the search system is defective based on defect determination results for each of the plurality of operation processes.

### CROSS REFERENCE TO RELATED APPLICATION

The present application claims priority to Korean Patent Application No. 10-2024-0168416, filed Nov. 22, 2024, the entire contents of which are hereby incorporated by reference in their entirety.

### BACKGROUND

The dictionary definition of artificial intelligence (AI) is a technology that realizes human abilities, such as learning ability, reasoning ability, perceptual ability, and natural language understanding, through computer programs. The AI has achieved remarkable advancements due to deep learning.

For example, thanks to the advancement of AI, various language models have been developed. The language models have reached a level at which they not only recognize text and understand its meaning, but also extract information from vast amounts of text data, such as documents, classify the extracted information, and furthermore generate text directly.

The language models are actively utilized in various fields, and are utilized in various fields which may be performed based on text, such as search engines, document writing (e.g., resume writing, report writing, post writing), free conversation on diverse topics, data parsing (e.g., data summarization, classification, etc.) from given texts, expert knowledge provision, programming, and transforming given sentences into appropriate styles. In addition, Korean Patent Laid-Open Publication No. 10-2024-0004054 discloses a method for generating marketing phrases for a target to be advertised using a language model.

Furthermore, the language model moves beyond a keyword-based search engine and is utilized in generative AI search services that perform searches according to a user intent expressed in natural language and provide results of the searches as answers.

With the emergence of such generative AI search services, various studies are being conducted to ensure the quality of service's tasks. However, the defect determination of generative AI search services relies on humans. Human determination has limitations in terms of cost, time, manpower, and objectivity, and no evaluation is conducted on each individual action process performed during service provision.

### SUMMARY

The inventive concepts relate to a method and system for defect determination in a system providing a generative artificial intelligence (AI)-based search service.

The inventive concepts are directed to providing a method and system for determining and analyzing defects in a generative artificial intelligence (AI)-based search system in consideration of operation processes of the search system.

More specifically, the inventive concepts are directed to providing a method and system capable of independently evaluating defects in each, or one or more, operation processes of a search system and collecting these evaluated defects to comprehensively determine defects across the entire process of the search system.

Some example embodiments of the inventive concepts are directed to providing a method and system for defect evaluation and determination capable of providing results of defect determination of a search system in the form of a report.

Some example embodiments of the inventive concepts disclose a method, for defect determination in a generative AI-based search system, the method including collecting a user query input to the generative AI-based search system, collecting an answer from the AI-based search system corresponding to the user query, collecting log data for each of a plurality of operation processes of the AI-based search system processed to output the answer to the user query, determining whether each of the plurality of operation processes is defective based on at least one of the user query, the answer, or the respective log data, and determining whether the search system is defective based on respective defect determination results for each of the plurality of operation processes.

According to some example embodiments of the inventive concepts, a system for defect determination in a generative AI-based search system includes a memory and at least one processor, wherein the memory and the processor are configured to collect a user query input to the generative AI-based search system, collect an answer from the AI-based search system corresponding to the user query, collect log data for each of a plurality of operation processes of the AI-based search system processed to output the answer to the user query, determine whether each of the plurality of operation processes is defective based on at least one of the user query, the answer, or the respective log data, and determine whether the search system is defective based on respective defect determination results for each of the plurality of operation processes.

According to some example embodiments of the inventive concepts, a non-transitory computer-readable medium stores a program which, when executed by one or more processors in an electronic device, cause the one or more processors to perform a method including collecting a user query input to the generative AI-based search system, collecting an answer from the AI-based search system corresponding to the user query, collecting log data for each of a plurality of operation processes of the AI-based search system processed to output the answer to the user query, determining whether each of the plurality of operation processes is defective based on at least one of the user query, the answer, or the respective log data, and determining whether the search system is defective based on respective defect determination results for each of the plurality of operation processes.

According to the method and system for defect determination in a generative AI-based search system of the inventive concepts, by collecting the user query, the answer to the user query, and/or the log data for each, or one or more, of the plurality of operation processes of the search system 200 processed to output the answer, it is possible to acquire the defect evaluation results of the search system 200.

For example, according to the method and system for defect determination in a generative AI-based search system of the inventive concepts, by using at least some of the user query, the answer, and the respective log data to independently determine whether each, or one or more, of the plurality of operation processes is defective, it is possible to accurately determine the defects occurring in each, or one or more, of the plurality of operation processes and establish the improvement measures for enhancing the quality of each, or one or more, operation process.

For example, according to the method and system for defect determination in a generative AI-based search system of the inventive concepts, by using the defect determination results for each, or one or more, of the plurality of operation processes, it is possible to determine whether the search system is defective. As a result, according to the inventive concepts, by acquiring the objective evaluation indicators regarding whether the answer provision process has been normally performed, the quality of the provided answer, and/or the user satisfaction, it is possible to enhance the stability and service quality of the search system.

### BRIEF DESCRIPTION OF THE DRAWINGS

FIG. 1 is a block diagram for describing a system for defect determination in a generative AI-based search system according to the inventive concepts.

FIG. 2 is a flowchart for describing a method for defect determination in a generative AI-based search system according to the inventive concepts.

FIGS. 3 and 4 are conceptual diagrams illustrating a method for determining whether each of the plurality of operation processes of the search system according to the inventive concepts are defective.

FIGS. 5 and 6 are conceptual diagrams for describing a method for defect determination in a search system according to the inventive concepts.

FIG. 7 is a conceptual diagram illustrating defect determination results of the search system according to the inventive concepts.

### DETAILED DESCRIPTION

Hereafter, some example embodiments of the inventive concepts will be described in detail with reference to the accompanying drawings and the same or similar components are given the same reference numerals regardless of the reference numbers of figures and are not repeatedly described. In addition, terms “module” and “unit” for components used in the following description are used only to easily describe the example embodiments. Therefore, these terms do not have meanings or roles that distinguish from each other in themselves. Further, when it is determined that a detailed description for the related known art in describing some example embodiments disclosed in the present specification may obscure the gist of the inventive concepts, a detailed description thereof will be omitted. Further, it should be understood that the accompanying drawings are provided only in order to allow some example embodiments disclosed in the present specification to be easily understood, and the spirit of the inventive concepts are not limited by the accompanying drawings, but includes all the modifications, equivalents, and substitutions included in the spirit and the scope of the inventive concepts.

Terms including ordinal numbers such as “first”, “second”, etc., may be used to describe various components, but the components are not to be construed as being limited to the terms. The terms are used to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween.

Singular expressions are intended to include plural expressions unless the context clearly represents otherwise.

It will be further understood that terms “include”, “have”, or the like used in the present specification specify the presence of features, numerals, steps, operations, components, parts mentioned in the present specification, or combinations thereof, but do not preclude the presence or addition of one or more other features, numerals, steps, operations, components, parts, or combinations thereof.

some example embodiments of the inventive concepts determine whether a generative artificial intelligence (AI)-based search system is defective, and provide a report including objective indicators using defect determination results.

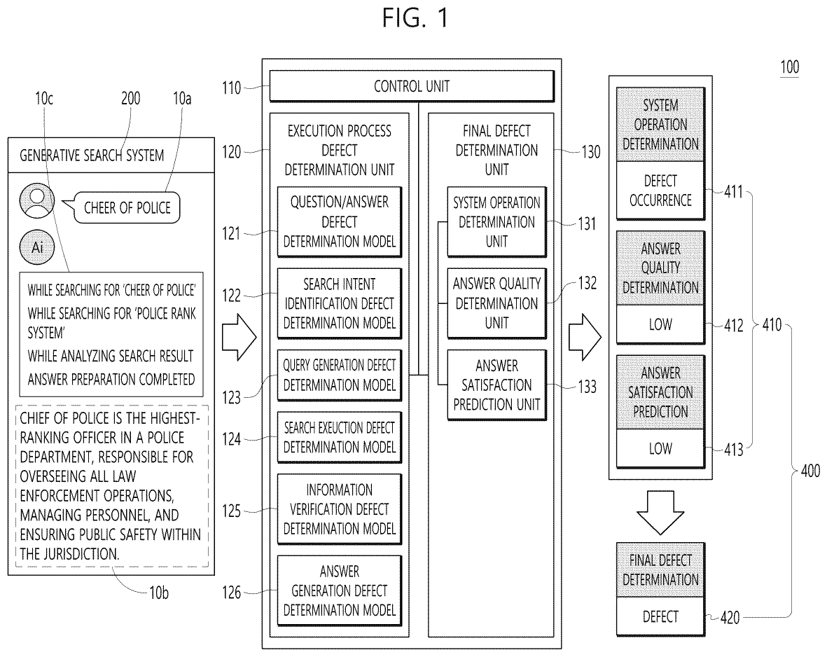

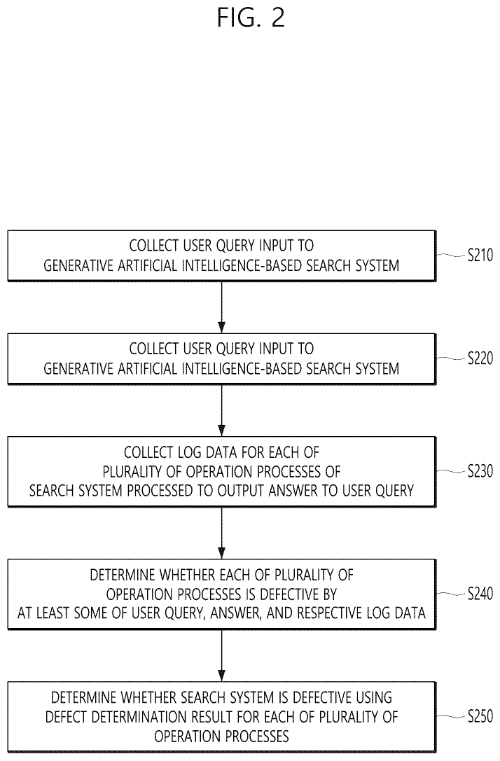

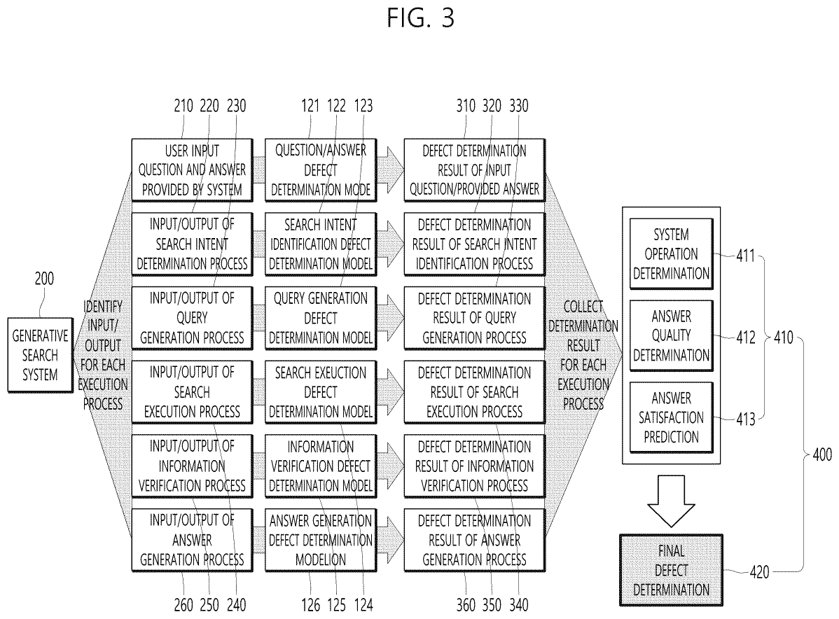

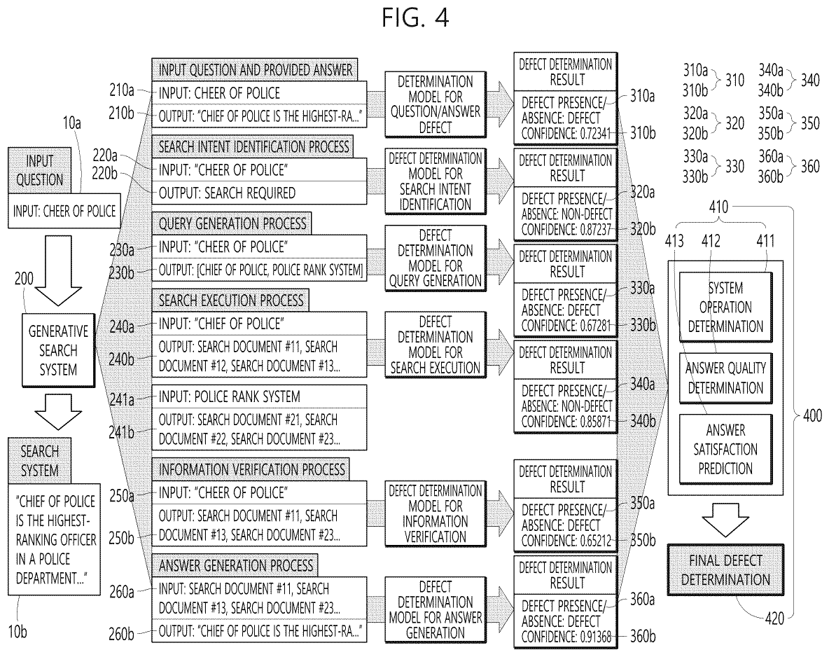

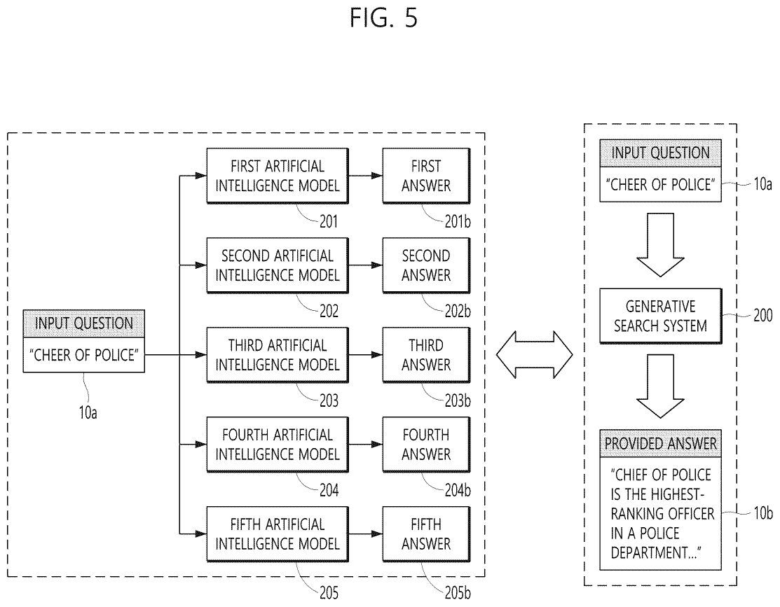

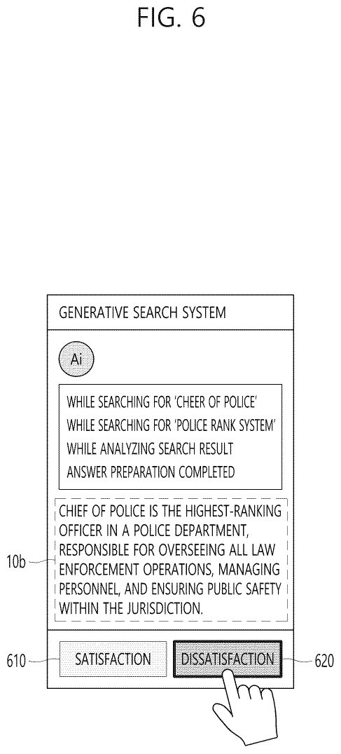

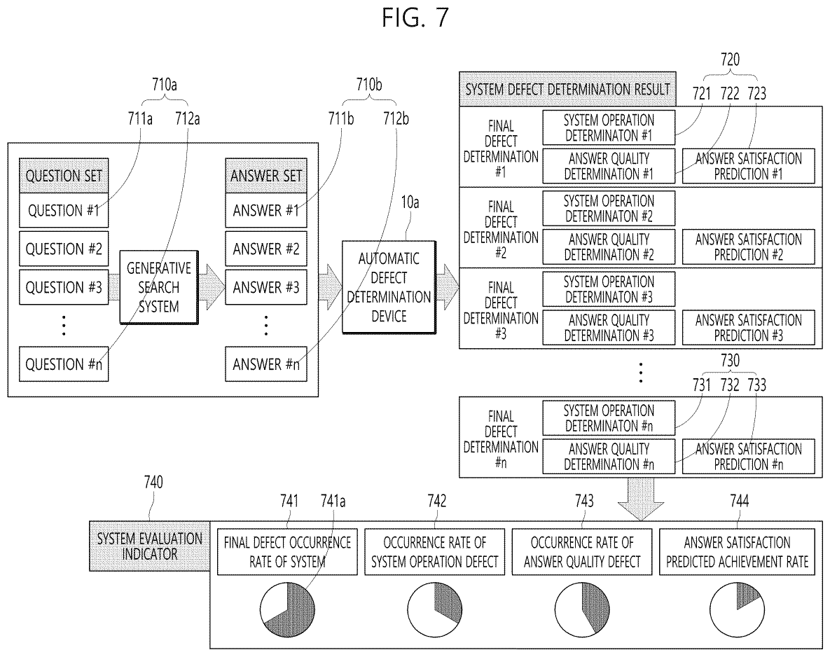

Hereinafter, a method for defect determination in a generative AI-based search system will be described in more detail with the attached drawings. FIG. 1 is a block diagram for describing a system for defect determination in a generative AI-based search system according to the inventive concepts. FIG. 2 is a flowchart for describing a method for defect determination in a generative AI-based search system according to the inventive concepts, FIGS. 3 and 4 are conceptual diagrams illustrating a method for determining whether each of the plurality of operation processes of the search system according to the inventive concepts are defective, FIGS. 5 and 6 are conceptual diagrams for describing a method for defect determination in a search system according to the inventive concepts, and FIG. 7 is a conceptual diagram illustrating defect determination results of the search system according to the inventive concepts.

As illustrated in FIG. 1, the system 100 for defect determination in a generative AI-based search system according to the inventive concepts may determine defects in a generative (hereinafter referred to as a “generative search system”), analyze defect determination results, and/or provide the analyzed defect determination results as reports and/or monitoring information.

In the inventive concepts, the “generative AI-based search system” (also referred to as a “generative search system” or “search system”) performs a search using a generative AI model to provide an answer to a user query 10a (e.g., “Cheer of Police”), and uses the search results to provide an answer 10b to the user.

The generative search system 200 may be configured to perform a plurality of operation processes to provide the answer 10b corresponding to the user query 10a.

In the inventive concepts, the plurality of operation processes may refer to a series of operation processes of the search system that are evaluated to determine whether the answer 10b of the generative search system corresponding to the user query is appropriate.

For example, the generative search system 200 may perform at least one of i) (search intent identification operation process) an operation process of determining whether to perform of a search based on the intent of the user query 10a and determining which search engine in a domain to use if the search is determined to be performed, ii) (query generation) an operation process of generating at least one of a search query, an image, and/or a vector representation for a search using a generative AI model for the user query 10a, iii) (search execution) an operation process of securing search results related to the user query 10a through a search engine for at least one of the search query, image, and/or vector representation generated for the search, iv) (information verification) an operation process (an operation process of leaving search results that are greater than or equal to a certain criterion) of determining the relevance of the user query 10a based on the secured search results and specifying the search results that are greater than or equal to a certain criterion, and v) (answer generation) an operation process of generating the answer 10b to the user query 10a based on the specified search results.

The operation process of the generative search system 200 described above is an example for convenience of description. The operation process of the generative search system 200 in some example embodiments may include all, or one or more, operation processes necessary, or sufficient, to provide the answer 10b to the user query 10a through the search. For example, the generative search system 200 may include all, or one or more, operation processes necessary, or sufficient, to provide services, such as translation, summarization, coding, document creation, and/or conversion of given sentences into sentences of an appropriate style.

In the present disclosure, defects refer to a case where the generative AI search system 200 generates incorrect results and/or does not function as intended during the operation process. Examples of the defect include misinterpreting the meaning of input data, providing irrelevant data, omitting necessary data, etc.

The defects may be understood as defects in output data output during the corresponding process, with respect to input data input to each, or one or more, operation process. For example, the type of defects occurring in each, or one or more, of the plurality of operation processes may be different from each other.

The defect in the search intent identification process occurs when the search intent identification model fails to correctly interpret the user query and misinterprets the intent. For example, when a user queries “Cheer of Police” and the search intent identification model misinterprets the search query as contents supporting the police rather than a police rank, this may be determined as a defect.

Definition of defect: The defect in the search query generation process occurs when the search query generation model generates incorrect search queries, images, and/or vector representations that fail to reflect the user intent. When the generated search query is too general and/or lacks relevance, this may also be determined as a defect. For example, when the user query is the “Cheer of Police,” but the generated search query was information related to “support for police safety,” this may be determined as a defect.

In some example embodiments, the defect in the search execution process occurs when the search model fails to secure correct search results based on a search query. It may be determined that the defect has occurred when the search engine returns inaccurate and/or low-relevance results, and/or when the search itself fails. For example, when the search model returns results for completely, (or substantially), unrelated police equipment or other rank systems in response to a search query for the “Cheer of Police,” this may be determined as a defect.

The defect in the information verification process occurs when the search results secured by the information verification model incorrectly determine how relevant the search results are to the user query. The cases where a result with high relevance is excluded or a result with low relevance is selected may be determined as a defect.

The defect in the answer generation process occurs when the answer generation model fails to generate an appropriate and/or accurate answer to a user query. For example, the cases where an inappropriate answer is generated based on the selected search results or key information is missing may be determined as a defect. For example, when the user query is “Cheer of Police,” but the answer generated by the answer generation model refers to “Cheer of Police is a mood of the police,” this may be determined as a defect.

These defects may be classified and/or defined based on at least one of operation process, function, severity, cause, and/or user impact. For example, the defect may be classified based on severity as critical errors, performance degradation, and/or minor errors. In some example embodiments, the defect may be classified based on cause, such as data bias, model structural issues, and insufficient training data. In some example embodiments, the defect may be classified based on the impact on the user, such as user inconvenience, service errors, and/or information errors. However, this is an example for convenience of description, and the criteria for defining the defect are not limited thereto.

The system 100 for defect determination in a generative AI-based search system according to the inventive concepts may analyze the operation process of the generative search system 200 by dividing the operation process into detailed steps, and generate, based on the analysis results of the operation process, a defect determination result in terms of whether the answer provision process is performed normally, the quality of the provided answer, and/or the user satisfaction with the provided answer. Based on the defect determination result, the inventive concepts may automatically perform a final defect determination in the generative search system 200.

The system 100 (hereinafter referred to as the “defect determination system”) for defect determination in a generative AI-based search system according to the inventive concepts may include at least one of a control unit 110, an operation process defect determination unit 120 (or an operation process defect determination unit) including at least one defect determination model 121 to 126, and/or a final defect determination unit 130.

The control unit 110 may perform overall control necessary, or sufficient, for determining the defect in the generative search system 200. The control unit 110 may also be referred to as a processor.

Based on the defect determination models 121 to 126, the control unit 110 may determine whether the answer 10b of the generative search system 200 to the user query 10a is defective. For example, the control unit 110 may determine whether each, or one or more, of the plurality of operation processes that generate the answer 10b to the user query 10a in the generative search system 200 is defective, and may ultimately determine whether the generative search system 200 is defective. The control unit 110 may use the defect determination results to generate and provide a defect report (or monitoring information) for the generative search system 200.

The operation process defect determination unit 120 may determine whether at least one of the plurality of operation processes of the search system 200 processed to output an answer to the user query 10a is defective.

The operation process defect determination unit 120 may include a defect determination model that determines whether each, or one or more, of the plurality of operation processes is defective. This defect determination model may include at least one of a large language model (LLM), a rule-based model, and/or a statistics-based model.

The operation process defect determination unit 120 may process data generated during the data processing of the generative search system 200 as input to the large language model to obtain defect determination results for each, or one or more, of the plurality of operation processes from the large language model (LLM).

In some example embodiments, the operation process defect determination unit 120 may use the rule-based model. The rule-based model may be built based on specific defect patterns and/or defect rules that repeatedly occur in the operation process of the generative search system 200.

Such a rule-based model may generate prediction data for each, or one or more, result of the operation process of the generative search system 200.

For example, the rule-based model may misidentify the search intent for the user query 10a (e.g., “Cheer of Police”) based on defect patterns (e.g., search intent distortion, insufficient background information reflection, etc.) that repeatedly occur in the operation process of “identifying the search intent” to generate defective prediction data (e.g., prediction data that interprets the words “Police” and “Cheer” separately and distorts the search intent into “police-related cheering”) as output. The rule-based model may generate a plurality of different prediction data sets based on defined defect patterns and/or defect rules.

In some example embodiments, the rule-based model may sample data related to the generative search system 200 to define defect types for each, or one or more, of the plurality of operation processes and detect the defects in each, or one or more, of the plurality of operation processes. For example, the rule-based model may randomly select log data used in each, or one or more, of the plurality of operation processes and, based on the rules, acquire the defect determination results of the selected log data based on the rules (such operations may also be performed by a human). When a specific defect pattern and/or defect is discovered in the sampled results, the rule-based model may identify the defect as the defect types for each, or one or more, of the plurality of operation processes and, based on this, detect the defects in each, or one or more, of the plurality of operation processes.

The operation process defect determination unit 120 may compare the predicted data predicted for each, or one or more, of the plurality of operation processes in the rule-based model with the output data generated as actual execution results of each, or one or more, of the plurality of operation processes in the generative search system 200, thereby determining whether the plurality of operations of the generative search system 200 are defective. For example, the operation process defect determination unit 120 may determine that the corresponding operation is defective when the output data corresponding to the predicted data of the rule-based model is the output of the generative search system 200. Alternatively, when the actual output data of the generative search system 200 is not included in the predicted data of the rule-based model, the operation process defect determination unit 120 may determine that the corresponding operation is not defective.

In some example embodiments, the operation process defect determination unit 120 may use the statistics-based model. For example, the statistics-based model may generate predicted data having defects based on statistical results for each, or one or more, defect type occurring in the operation process of the generative search system 200. The operation process defect determination unit 120 may compare the predicted data generated in the statistics-based model with the output data output as actual execution results of each of the plurality of operation processes in the generative search system 200, thereby determining whether the plurality of operations of the generative search system 200 are defective.

The operation process defect determination unit 120 may selectively use at least one of the large language model (LLM), the rule-based model, and/or the statistics-based model, depending on which operation process is subject to defect determination, thereby determining whether the operation process is defective.

For example, the operation process defect determination unit 120 may use the large language model and the statistics-based model to determine the defects in the operation process that identifies the search intent, and the rule-based model to determine the defects in the query generation operation process.

For example, in the inventive concepts, the determination of each, or one or more, of the plurality of operation processes may differ in at least one of the models used for the defect determination, the type of data used as the basis for the determination, and/or the determination method.

In some example embodiments, as illustrated in FIG. 1, the defect determination system 100 according to the inventive concepts may include a plurality of different defect determination models 121 to 126 for determining whether each, or one or more, of the plurality of operation processes is defective. Each, or one or more, of the plurality of defect determination models 121 to 126 may be configured to determine whether each, or one or more, of the different operation processes among the plurality of operation processes is defective. For example, in the generative search system 200, when the operation process is performed as a search intent identification, query generation, search execution, information verification, and answer generation, the defect determination system 100 may include a search intent identification defect determination model 122, a query generation defect determination model 123, a search execution defect determination model 124, an information verification defect determination model 125, and an answer generation defect determination model 126, respectively. The defect determination system 100 may further include the question/answer defect determination model 121 that determines whether the entire operation process of the generative search system 200 is defective (whether the answer to the user query is defective). Each, or one or more, of the plurality of different defect determination models 121 to 126 may determine whether the corresponding operation process is defective based on at least one of the large language model (LLM), the rule-based model, and/or the statistics-based model.

In some example embodiments, the determination of whether each, or one or more, of a plurality of operation processes is defective may be performed by one defect determination model. For example, one defect determination model may selectively use at least one of the large language model (LLM), the rule-based model, and/or the statistics-based model, depending on the operation process being determined, to determine the defects in the corresponding operation process. In the inventive concepts, the defect determination for the plurality of operation processes is performed individually, and may be performed in one defect determination model through different data processing, and/or the defect determination for the corresponding operation process may be performed in the defect determination models corresponding to each, or one or more, of the plurality of operation processes. In the inventive concepts, the plurality of defect determination models may be conceptually distinct concepts, but are not necessarily physically distinct.

To clearly describe the defect determination in each, or one or more, of the plurality of operation processes, it is described that whether each, or one or more, of the plurality of operation processes is defective is determined by the plurality of defect determination models 121 to 126.

In some example embodiments, the final defect determination unit 130 may use the defect determination results for each, or one or more, of the plurality of operation processes to ultimately determine whether the search system is defective for the overall operation of the generative search system 200. The final defect determination unit 130 may determine defects in each, or one or more, of the plurality of defect categories related to defects in the generative search system 200.

In some example embodiments, the plurality of defect categories may include at least one of a system operation determination category 411, an answer quality determination category 412, and/or an answer satisfaction prediction category 413.

In the inventive concepts, the system operation determination category 411 may be understood as determining the defect in the answer output by the generative search system 200 to the user query.

In the inventive concepts, the answer quality determination category 412 may be understood as determining the objective quality in the answer output by the generative search system 200 to the user query.

The final defect determination unit 130 may include at least one of the system operation determination unit 131, the answer quality determination unit 132, and/or the answer satisfaction prediction unit 133, which determine the defects in each, or one or more, of the plurality of defect operation categories.

In the inventive concepts, the answer satisfaction prediction category 413 may be understood as predicting a user's subjective quality evaluation of the answer output from the generative search system 200.

The system operation determination unit 131 may use the defect determination results of each, or one or more, of the plurality of operation processes to determine whether the entire answer generation process of the generative search system 200 is defective, and generate the defect determination result for the system operation.

For example, the system operation determination unit 131 may generate the determination result for whether the entire answer generation process of the generative search system 200 is performing normally and/or the percentage of steps that are performing normally as the determination result for the system operation.

The answer quality determination unit 132 may determine the objective quality of the answer 10b based on the objective quality of the results of the generative search system 200 and generate a label and/or numerical value for the objective quality of the answer 10b as the determination result for the answer quality.

The answer satisfaction prediction unit 133 may determine the user satisfaction of the answer 10b based on the subjective quality of the results of the generative search system 200 and generate a label and/or numerical value for the user satisfaction of the answer 10b as the determination result for the answer quality.

In the inventive concepts, whether the generative search system 200 is defective may be ultimately determined using the determination results for each, or one or more, of the plurality of operation processes, the system operation, the quality of the answer 10b, and/or the answer satisfaction prediction results. In some example embodiments of the inventive concepts, a defect report for the generative search system 200 may be generated and provided using all results 400, including the final determination result 420.

In some example embodiments, although not illustrated, the defect determination system 100 may further include at least one of a communication unit and/or a storage unit. The communication unit may be configured to communicate with an external server and/or a user terminal. At least one of the log data 10c for each, or one or more, of the plurality of operation processes of the search system processed to output the answer to the user query may be received. For example, the communication unit may provide the defect report of the generative search system to the user terminal. The storage unit is also called a database (DB) or memory, and may store various pieces of information necessary, or sufficient, for the defect determination of the generative search system. In the inventive concepts, the storage unit (database) may be provided in the defect determination system 100 itself. In some example embodiments, at least some of the storage unit (database) may refer to at least one of an external database and/or a cloud storage (or a cloud server). For example, the storage unit may be sufficient as long as it is a space where the information necessary, or sufficient, for the defect determination of the generative AI-based search system according to the inventive concepts is stored, and it may be understood that there are no restrictions on physical space. Accordingly, in the inventive concepts, the storage unit, the database, the external storage, and the cloud storage (or the cloud server) are not separately distinguished, and are all referred to as a “database.”

Hereinafter, a method for determining defects in a plurality of operation processes of the generative search system using the above-described configuration and determining whether the generative search system 200 is ultimately defective based on the determined defect will be described in detail.

In the inventive concepts, a process may be performed to collect the user queries input to the generative AI-based search system (S210, see FIG. 2). In the inventive concepts, a process may be performed to collect answers from the search system corresponding to the user queries (S220, see FIG. 2). The inventive concepts may collect log data for each, or one or more, of the plurality of operation processes of the search system processed to output the answers to the user queries.

To determine defects in the functionality of the generative search system 200, the control unit 110 may collect the user queries 10a and/or the answers 10b from the generative search system 200 to each, or one or more, of the user queries 10a.

For example, the control unit 110 may collect the user queries 10a (e.g., “Cheer of Police”) input to the generative search system 200 and/or the answers 10b (e.g., “Chief of Police is among police officer ranks . . . ”) generated by the generative search system 200 to be provided to the user.

To determine the defects in the generative search system 200, the control unit 110 may collect a plurality of user queries input to the generative search system 200 and multiple answers 10b corresponding to each of the plurality of user queries 10a. The control unit may collect multiple log data and/or multiple search queries, as described below. The control unit 110 may match all, or one or more, of the user query 10a, the answer 10b corresponding to the user query 10a, the search query, and/or the log data and process the matched user query 10a, answer 10b, search query, and/or log data as a single dataset.

In the inventive concepts, this single dataset may be referred to as analysis data or an analysis dataset. For convenience of description, the following description will focus on an analysis data set including a single user query 10a (e.g., “Cheer of Police”).

As illustrated in FIG. 3, the control unit 110 may collect log data 210 to 260 for each, or one or more, of the plurality of operation processes processed in the generative search system 200 in order to generate the answer 10b to the user query 10a and provide the generated answer 10b to the user.

In some example embodiments, the log data is data that records the processes occurring while the generative search system 200 operates to generate and provide the answer 10b to the user query 10a, and may include data regarding at least one of the status, input, output, event, and/or data processing steps of each, or one or more, operation process.

The log data for each, or one or more, of the plurality of operation processes may vary depending on the properties of each, or one or more, of the plurality of operation processes.

For example, the log data for the search intent identification operation process may include at least one of a user query log, an intent identification log, and/or an intent identification result log. As such log data, the user query 10a log may include the user query 10a input by a user, and/or a record of how the generative search system (or the search intent identification model) in the search intent identification operation process interpreted the user query (10a) as to what intent the user query has and whether search is required, or sufficient,.

The log data for the search query generation operation process may include at least one of a query log, an image generation log, and/or a vector representation generation log generated by the generative search system (search query generation model). The log data may include records of the search queries and/or additional image and/or vector representations generated by the search query generation model for the search, as well as records of the process showing which search queries are generated based on the user-specified query.

The log data for the search execution operation process may include at least one of a search query execution log, a search engine log, and/or a search result log, and may include records of searches performed using the search query through the search engine. For example, the log data may include a record of what search queries are used and what data are returned as search results.

The log data for the information verification operation process may include at least one of a search result evaluation log, a relevance determination log, and/or a final selection result log. The log data may determine how relevant the secured search results are to the user query, and include records of search results selected based on a certain threshold, as well as records of the relevance evaluation scheme and/or the criteria.

The log data for the answer generation operation process may include an answer generation log and/or an answer content log, and based on the selected search results, the answer generation model may record the process by which the final answer to be provided to the user is generated. The log data may also include records regarding how the answer is structured and/or which search results are reflected.

In some example embodiments, the control unit 110 may collect the search query corresponding to the user query generated by the generative search system. The control unit 110 may collect the search query based on the execution of the search operation process to output the answer 10b to the user query 10a.

For example, the control unit 110 may determine whether the search operation process has been performed based on the log data. Based on the confirmation result, the control unit 110 may collect the search query generated by the generative search system (search query generation model).

The control unit 110 may collect an analysis data set including at least one of the user query 10a, the answer 10b, the search query, and/or the log data. The control unit 110 may collect the analysis data set in real time based on the answer 10b provided to the user query 10a by the generative search system 200. In some example embodiments, the control unit 110 may collect the analysis data set at regular intervals.

Based on the collection of the analysis data set, the control unit 110 may determine in real time whether each, or one or more, of the plurality of operation processes of the generative search system 200 is defective. For example, the control unit 110 may store the analysis data set in the database and determine whether the generative search system is defective when the plurality of analysis data sets are collected.

In the inventive concepts, a process for determining whether each, or one or more, of the plurality of operation processes is defective may be performed using at least some of the user queries, the answers, and/or the respective log data (S240, see FIG. 2).

In the inventive concepts, the type of data that serves as the basis for defect determination in each, or one or more, of the plurality of operation processes may be predefined, or alternatively given, and exist. As described above, the inventive concepts may include the plurality of different defect determination models 121 to 126 for determining whether each, or one or more, of the plurality of operation processes is defective. The plurality of defect determination models 121 to 126 may differ in at least one of the operation processes to be determined, the type of data used to determine whether the operation process is defective, the determination criteria, the determination method, and/or the model (a large language model, a rule-based model, and/or a statistics-based model) used for the determination.

The control unit 110 may selectively use the data and/or defect determination model depending on which of the plurality of operation processes is being determined as a defect to determine whether the corresponding operation process is defective.

For example, the control unit 110 may selectively specify the user queries, the answers, the log data, and/or the data corresponding to the search queries based on the predefined, or alternatively given, data types for each, or one or more, of the plurality of operation processes. The control unit 110 may process at least some of the user queries, the answers, the respective log data, and/or the data corresponding to the search query specified according to the operation process, as the input data for the plurality of defect determination models.

For example, as illustrated in FIG. 4, to determine whether the entire operation process is defective, the control unit 110 may select a user query 210a (e.g., “Cheer of Police”) and its corresponding answer 210b (e.g., “Chief of Police is among a police officer rank . . . ”) and process the user query 210a and the answer 210b as inputs for the question/answer model. In order to determine the search intent, the control unit 110 may select a user query 220a (ex: “Cheer of Police”) and log data 220b indicating whether a search is necessary (ex: “search required”) and process the user query 220a and the log data 220b as inputs of the search intent determination defect determination model 122. In order to determine whether the query generation process is defective, the control unit 110 may select a user query 230a (ex: “Cheer of Police”) and a search query 230b (ex: “[Chief of Police], [Police rank system]”) and process the user query 230a and the search query 230b as inputs of the query generation defect determination model. In order to determine whether the search execution operation process is defective, the control unit 110 may process search queries 240a and 241a (ex: “Chief of Police”, “Police rank system”) and log data 240b and 241b including search results (ex: “Search document #11 . . . ”, “Search document #21 . . . ”) as input data of the search execution determination model. In order to determine whether the information verification operation process is defective, the control unit 110 may process a user query 250a (ex: “Cheer of Police”) and log data 250b including selected search results (ex: “Search document #11, Search document #13, Search document #23 . . . ”) as input data of the information verification defect determination model. In order to determine whether the answer generation operation process is defective, the control unit 110 may process log data 260a including the selected search results (ex: “search document #11, search document #13, search document #23 . . . ”, 250b) and answers 260b (ex: “Chief of Police is among the police officer ranks . . . ”) as inputs to the answer generation defect determination model.

The control unit 110 may generate different prompts to be input to each, or one or more, of the plurality of defect determination models 121 to 126. When determining whether the operation process is defective using the large language model (LLM) in at least one of the plurality of defect determination models 121 to 126, the control unit 110 may generate a prompt for processing as input to a specific defect determination model.

In some example embodiments, as described above, in the inventive concepts, the defect determination for the plurality of operation processes may be performed in one defect determination model through different data processing, or the defect determination for the corresponding operation process may be performed in the defect determination models 121 to 126 corresponding to each, or one or more, of the plurality of operation processes. When determining defects in each, or one or more, of the plurality of operation processes in one defect determination model, the prompts may be generated by specifying each, or one or more, of the plurality of operation processes. For example, when the defect determination is performed in each, or one or more, of the plurality of defect determination models 121 to 126, the control unit 110 may generate the prompts containing the above-described data, respectively.

In some example embodiments, the control unit 110 may use the main defect determination model, which includes the plurality of detailed defect determination models 121 to 126, to generate the prompts for each, or one or more, of the plurality of detailed defect determination models 121 to 126. Hereinafter, for convenience of description, it will be described that each of a plurality of defect determination models 121 to 126 is present. However, in the inventive concepts, the plurality of defect determination models may be conceptually distinct concepts, but are not necessarily physically distinct.

The control unit 110 may generate different prompts to be input to each, or one or more, of the plurality of defect determination models 121 to 126 using the large language model.

In the inventive concepts, different defect determination instruction statements to be input to the plurality of operation models may be predefined, or alternatively given, and exist for each, or one or more, of the plurality of operation processes.

For the plurality of operation processes, the control unit 110 may generate the different prompts for each, or one or more, of the plurality of operation processes such that the different instruction statements corresponding to each, or one or more, of the plurality of operation processes is included according to the predefined, or alternatively given, instruction statements.

The control unit 110 may generate the prompts such that the prompts include at least one of what operation process is to be determined, what types of data are predefined, or alternately given, for this purpose, and/or what data are processed as input data to determine the operation process.

For example, the control unit 110 may generate the prompts for each, or one or more, of the plurality of operation processes such that each, or one or more, of the plurality of operation processes includes predefined, or alternatively given, data among the user queries, the answers, the respective log data, and/or the data corresponding to the search queries.

For example, to determine whether the search intent identification operation is defective, the control unit 110 may generate the prompt such as, “Compare the user query input by the user with the intent identification result of the search intent identification model to determine whether the intent identification was accurate. The case where the intent was incorrectly identified is determined as a defect. The intent identification log is as follows: {User query—“Cheer of Police”}. {Search required}, Return whether a defect is present,” and process the prompt as input to the search intent identification defect determination model 122.

As another example, to determine whether the search intent identification operation is defective, the control unit 110 may generate a prompt such as, “Review whether the search query, image, and vector representation generated by the model appropriately reflect the intent of the user query. The case where the generated search query is inaccurate or irrelevant determines as a defect. The generated search query is as follows: {Search query: [Chief of Police], [Police rank system]}, {User query: “Cheer of Police”}. Return whether the defect is present,” and process the prompt as input to the defect determination model 123.

As illustrated in FIG. 3, each, or one or more, of the plurality of defect determination models 121 to 126 may use the output of the large language model for different prompts to determine whether the operation processes corresponding to each, or one or more, of the plurality of defect determination models among the plurality of operation processes is defective, thereby generating defect determination results 310 to 360.

Each, or one or more, of the plurality of defect determination models 121 to 126 may output the respective defect determination results including information on whether the search system is defective, for any one of the plurality of operation processes

Each, or one or more, of the plurality of defect determination models 121 to 126 may further output confidence information for the defect determination results of a specific defect determination model which outputs the information on whether the search system is defective included in the defect determination result.

As illustrated in FIG. 4, each, or one or more, of the plurality of defect determination models 121 to 126 may output defect presence/absence information 310a to 360a (e.g., “defect” or “non-defect”) for each, or one or more, of the plurality of operation processes. The plurality of defect determination models may determine whether the plurality of operation processes are defective in various ways. For example, the plurality of defect determination models 121 to 126 may output the defect presence/absence information as “defect” or “non-defect” through a binary prediction scheme. For another example, the plurality of defect determination models 121 to 126 may score the presence/absence of the defect in an operation process, and output the defect presence/absence information as “defect” if the score is greater than or equal to a certain criterion, and as “non-defect” if the score is below a certain criterion.

In some example embodiments, each, or one or more, of the plurality of the defect determination models 121 to 126 may evaluate the confidence of its own defect determination and provide the evaluated confidence as confidence information 310b to 360b. For example, each, or one or more, of the plurality of defect determination models 121 to 126 may evaluate its own defect determination process which determines whether the operation process is defective, and evaluate how accurate, reliable, and/or error-free the defect determination process is, and output confidence information. The confidence may be evaluated in various ways.

For example, the confidence may be evaluated based on the statistical results of the statistics-based model (e.g., the accuracy of past defect determination results of a defect evaluation model). For another example, the confidence may be evaluated based on the defect rules referenced by the defect determination model in determining the defects in the operation process. The defect determination model may evaluate its own confidence by comparing the accuracy of the defect rules, the number of defect rules, and/or the relevance of the defect rule and input data. In some example embodiments, the control unit 110 may determine how the confidence is evaluated based the predefined, or alternatively given, data types for each, or one or more, of the plurality of operation processes and/or based on the defect determination model 121 to 126 performing the confidence evaluation. However, example embodiments are not limited to this example.

For example, the control unit 110 may select the rule-based model for an operation process in which deterministic patterns (e.g., intent-misclassification patterns or keyword omission patterns) are frequently observed, select the statistics-based model for an operation process in which historical defect frequency distributions are stable, and select the large language model (LLM) for an operation process requiring semantic interpretation or contextual judgment. The selection rule may be predefined, or alternatively given, for each operation process.

In the inventive concepts, a process for determining whether the search system is defective may be performed using the defect determination results for each, or one or more, of the plurality of operation processes (S250, see FIG. 2).

As illustrated in FIGS. 3 and 4, the control unit 110 may determine whether the generative search system 200 is defective using the defect determination results 310 to 360 output from each, or one or more, of the plurality of defect determination models. For example, the control unit 110 may use at least some of the defect presence/absence information 310a to 360a for each, or one or more, of the plurality of operation processes and confidence information 310b to 360b for each, or one or more, of the plurality of defect determination models to generate determination results 410 for each, or one or more, of the plurality of different defect categories associated with the defects in the generative search system 200.

In some example embodiments, the plurality of defect categories may include at least one of a system operation determination category 411, an answer quality determination category 412, and/or an answer satisfaction prediction category 413.

The control unit 110 may use the defect determination results of each, or one or more, of the plurality of operation processes to determine whether the entire answer generation process of the generative search system 200 is defective, and generate the defect determination result for the system operation.

In the inventive concepts, the system operation determination category 411 may be understood as determining the defect in the answer output by the generative search system 200 to the user query. The system operation determination may be performed in various ways.

For example, the control unit 110 may use the results of determining whether each, or one or more, of the plurality of operation processes is defective to generate the determination result for whether the entire answer generation process of the generative search system 200 is performing normally and/or the percentage of steps that are performing normally. For another example, as illustrated in FIG. 5, the control unit 110 may determine the system operation defect by comparing answers 201b to 205b acquired from different AI models 201 to 205 for the user query 10a with the answer 10b acquired from the generative search system 200. In some example embodiments, the different AI models 201 to 205 are included in the generative search system 200 and may be understood as performing at least some of the plurality of operation processes that are performed to generate the answer to the user query. For example, the control unit 110 may compare the result of determining whether the plurality of operation processes are defective, the prediction result that selectively combines at least some of the answers 201b to 205b of each, or one or more, model and the models 201 to 205 that perform each, or one or more, of the plurality of operation processes, and the actual answer 10b of the generative search system 200, thereby determining the operation process defect of the generative search system 200.

In some example embodiments, the answer quality determination category 412 may be understood as determining the objective quality in the answer output by the generative search system 200 to the user query.

The control unit 110 may determine the objective quality of the answer 10b in terms of the objective quality of the results of the generative search system 200 and generate a label and/or numerical value for the objective quality of the answer 10b as the determination result for the answer quality. For example, the control unit 110 may use the defect determination model 121 that determines the overall operation process to evaluate the objective quality, such as whether the answer of the generative search system 200 is accurate and/or whether the answer of the generative search system 200 corresponds to the user intent.

In the inventive concepts, the answer satisfaction prediction category 413 may be understood as predicting a user's subjective quality evaluation of the answer output from the generative search system 200.

The control unit 110 may determine the user satisfaction of the answer 10b in terms of the subjective quality of the results of the generative search system 200 and generate a label and/or numerical value for the user satisfaction of the answer 10b as the determination result for the answer quality. For example, as illustrated in FIG. 6, the control unit 110 may collect the user satisfaction evaluation information 610 and 620 (e.g., “satisfied” or “dissatisfied”) for the answer 10b. This satisfaction evaluation information is matched with the user queries and answers and stored in the database. The control unit 110 may refer to the database to predict and evaluate the user satisfaction.

In some example embodiments, the control unit 110 may use the determination results for each, or one or more, of the plurality of defect categories to determine whether the search system is ultimately defective.

For example, the control unit 110 may collect the defect determination results from the process of generating a plurality of user queries 710a and a plurality of answers 720a corresponding to each, or one or more, of the plurality of user queries, and determine whether the generative search system 200 is ultimately defective.

As illustrated in FIG. 7, the control unit 110 may use a defect determination result 720 of the generative search system 200 for outputting a first user query 711a and a first answer 711b to the first user query 711a through to a defect determination results 730 of the generative search system 200 for outputting an n-th user query 712a and an n-th answer 712b to the n-th user query 712a, thereby determining whether the generative search system 200 is ultimately defective.

For example, the control unit 110 may use a determination result 721 for a first system operation determination category and a determination result 731 for an n-th system operation determination category to generate statistical information (e.g., a defect rate) for the operation defects of the generative search system 200. Based on the statistical information, the control unit 110 may analyze whether the entire answer generation process is operating normally. For example, the control unit 110 may use the determination results 722 for the first answer quality determination category through to the determination results 731 for the n-th answer quality determination category to generate statistical information (e.g., a quality ratio) on whether the generative search system 200 generates answers with a certain quality criterion. For another example, the control unit 110 may use a determination result 723 for the first answer satisfaction prediction category through to a determination result 733 for the nth answer satisfaction prediction category to generate statistical information on changes in the predicted user satisfaction for the generative search system 200.

In some example embodiments, the control unit 110 may use the defect determination results for each, or one or more, of the plurality of operation processes to generate statistical information on the occurrence of defects in each, or one or more, of the plurality of operation processes.

Based on the final defect determination, the control unit 110 may generate and provide an evaluation indicator report 740 for the generative search system 200. The evaluation indicator report 740 may include at least one of statistical information 741 on the occurrence of final defects of the system, statistical information 742 on the occurrence of system operation defect, statistical information 743 on the occurrence rate of answer quality defect, and statistical information 744 on the predicted achievement rate of answer satisfaction. The evaluation indicator report 740 may further include graphical objects 741a (e.g., graphs) corresponding to each, or one or more, piece of statistical information.

According to some example embodiments, the system 100 for defect determination may improve the generative search system 200 based on an output of at least one of the execution process defect determination unit 120 and/or the final defect determination unit 130. For example, at least one of the user query 10a, the answer 10b, the user query 210a, the answer 210b, the user query 22a, the log data 220b, the user query 230a, the search query 230b, the search queries 240a and/or 241a, the log data 240b and/or 241b, the user query 250a, the log data 250b, the log data 260a, the answer 260b, and/or the evaluation indicator report 740 may be used to train (e.g., re-train and/or further train) the generative search system 200.

In some example embodiments, all, or one or more, of processes of the generative search system 200 may be trained based on the output of at least one of the execution process defect determination unit 120 and/or the final defect determination unit 130. For example, the output of at least one of the execution process defect determination unit 120 and/or the final defect determination unit 130 may be used as training data (e.g., new and/or additional training data) for training (e.g., re-training and/or further training) the generative search system 200. For example, in an example where the search execution defect determination model 124 determines that the search execution operation process performed by the generative search system 200 is defective, search queries 240a and/or 241a and/or log data 240b and/or 241b may be used as training data to train (e.g., re-train and/or further train) the generative search system 200.

In some example embodiments, a generative search system 200 trained (e.g., re-trained and/or further trained) by the system 100 for defect determination according to example embodiments may provide answers to user inquiries more accurately, more stably, and/or with enhanced service quality. For example, a generative search system 200 that provides an answer related to “support for police safety,” “a mood of the police,” etc. based on a user inquiry “Cheer of Police” prior to being trained by the system 100 for defect determination according to example embodiments may more correctly provide the answer 10b related to, for example, “Chief of Police is among police officer ranks . . . ” in response to the user query “Cheer of Police” after being trained (e.g., re-trained and/or further trained) by the system 100 for defect determination according to example embodiments.

According to some example embodiments, the system 100 for defect determination may automatically train (e.g., re-train, further train) the generative search system 200 based on outputs of at least one of the execution process defect determination unit 120 and/or the final defect determination unit 130 in response to at least one of the defect determination models 121 to 126 determining at least one of the of the plurality of operation processes of the generative search system 200 is defective.

In some example embodiments, the defect determination results for each of the plurality of operation processes may be mapped to corresponding model components of the AI-based search system 200. For example, a defect in the search intent identification process may trigger an update of an intent-classification module or its embedding projection layer; a defect in the query-generation process may be used to adjust a prompt-generation policy or fine-tune parameters of a query-generation LLM; and a defect in the search-execution process may be used to rebuild a retrieval index or re-weight retrieval scoring parameters. By applying the defect determination results to specific components of the pipeline, the AI-based search system 200 may be improved at the component level rather than by general retraining.

For example, the defect determination results may indicate that the search execution process repeatedly retrieves documents unrelated to the user intent. After the system 100 applies the defect-derived training data, the retrieval module of the AI-based search system 200 may significantly reduce the retrieval of low-relevance documents and increase the top-k relevance score. In another example, an answer-generation defect caused by hallucination may be corrected such that, after improvement, the answer-generation model omits incorrect fabricated content that had previously appeared in responses.

According to the method and system for defect determination in a generative AI-based search system of the inventive concepts, by collecting the user query, the answer to the user query, and the log data for each of the plurality of operation processes of the search system 200 processed to output the answer, it is possible to acquire the defect evaluation results of the search system 200.

According to the method and system for defect determination in a generative AI-based search system of the inventive concepts, by using at least some of the user query, the answer, and/or the respective log data to independently determine whether each, or one or more, of the plurality of operation processes is defective, it is possible to accurately determine the defects occurring in each, or one or more, of the plurality of operation processes and establish the improvement measures for enhancing the quality of each operation process.

According to the method and system for defect determination in a generative AI-based search system of the inventive concepts, by using the defect determination results for each, or one or more, of the plurality of operation processes, it is possible to determine whether the search system is defective. As a result, according to the inventive concepts, by acquiring the objective evaluation indicators regarding whether the answer provision process has been normally performed, the quality of the provided answer, and the user satisfaction, it is possible to enhance the stability and service quality of the search system. For example, a human may be limited to evaluating a user query and an answer provided by the generative search system 200, while, according to some example embodiments, the method and system 100 for defect determination of some example embodiments may individually evaluate each, or one or more, of the plurality of operation processes performed by the generative search system 200 to more accurately determine whether the search system is defective than a human may practically be capable of.

As described above, the inventive concepts may be implemented as computer-readable codes or instructions on a medium recording the program. For example, the inventive concepts may be provided in the form of the program.

In some example embodiments, the computer-readable medium may include all kinds of recording devices in which computer system-readable data is stored. An example of the computer-readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, and/or the like.

In some example embodiments, the computer-readable medium may be the server and/or cloud storage that includes storage and may be accessed by the electronic device via communication. For example, the computer may download the program according to the inventive concepts from the server and/or cloud storage via wired and/or wireless communication.

In some example embodiments, in the inventive concepts, the computer described above is an electronic device equipped with a processor, e.g., a central processing unit (CPU), and there are no particular limitations on its type.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The above-described detailed description is to be interpreted as being illustrative rather than being restrictive in all aspects. The scope of the inventive concepts is to be determined by reasonable interpretation of the claims, and all modifications within an equivalent range of the inventive concepts fall in the scope of the inventive concepts.

What is claimed is:

1. A method for defect determination in a generative artificial intelligence (AI)-based search system, the method comprising:
collecting a user query input to the generative AI-based search system;
collecting an answer from the generative AI-based search system corresponding to the user query;
collecting log data for each of a plurality of operation processes of the generative AI-based search system processed to output the answer to the user query;
determining whether each of the plurality of operation processes is defective based on at least one of the user query, the answer, or the respective log data; and
determining whether the generative AI-based search system is defective based on respective defect determination results for each of the plurality of operation processes.

2. The method of claim 1, further comprising:
collecting a search query corresponding to the user query generated by the generative AI-based search system,
wherein the determining of whether the generative AI-based search system is defective includes determining whether at least one of the plurality of operation processes is defective based on the search query.

3. The method of claim 2, wherein each of the plurality of operation processes has a corresponding type of data that serves as a basis for defect determination, and
the determining whether each of the plurality of operation processes is defective determines whether each of the plurality of operation processes is defective by selectively using at least one of the user query, the answer, the respective log data, or data corresponding to the search query depending on which of the plurality of operation processes is to be determined as defective.

4. The method of claim 3, wherein a defect determination system includes a plurality of different defect determination models for determining whether a corresponding operation process of the plurality of operation processes is defective, and
each of the plurality of defect determination models is configured to determine whether the corresponding operation process of the plurality of operation processes is defective.

5. The method of claim 4, wherein the plurality of operation processes includes a series of operation processes of the generative AI-based search system, and
the determining whether each of the plurality of operation processes is defective evaluates the series of operation processes to determine whether the answer from the generative AI-based search system corresponding to the user query is appropriate.

6. The method of claim 5, wherein each of the plurality of defect determination models is configured to output the respective defect determination results including information on whether the generative AI-based search system is defective, for respective operation processes of the plurality of operation processes.

7. The method of claim 6, wherein a defect determination result of the defect determination results includes confidence information for the defect determination result.

8. The method of claim 6, wherein the determining whether the generative AI-based search system is defective determines whether the search system is defective based on the defect determination results.

9. The method of claim 8, wherein the determining whether the generative AI-based search system is defective includes:
generating determination results for each of a plurality of different defect categories associated with the defect in the generative AI-based search system based on the defect determination results; and
determining whether the search system is defective based on the determination results for each of the plurality of different defect categories.

10. The method of claim 9, wherein the plurality of different defect categories includes at least one of a system operation determination category, an answer quality determination category, or an answer satisfaction prediction category.

11. The method of claim 4, wherein the determining whether the search system is defective includes processing at least one of the user query, the answer, the respective log data, or the data corresponding to the search query as input data for the plurality of defect determination models.

12. The method of claim 11, wherein the processing at least one of the user query, the answer, the respective log data, or the data corresponding to the search query as the input data for the plurality of defect determination models selectively processes at least one of the user query, the answer, the respective log data, or the data corresponding to the search query based on the corresponding type of data respectively associated with each of the plurality of operation processes.

13. The method of claim 4, wherein at least one of the plurality of defect determination models is configured to determine the defects a respective operation process of the plurality of operation processes by using a large language model (LLM).

14. The method of claim 13, wherein the determining whether the search system is defective includes generating different prompts to be input to each of the plurality of defect determination models using the large language model.

15. The method of claim 14, wherein the defect determination system includes, for each of the plurality of operation processes, different defect determination instruction statements to be input to the plurality of operation models, and
the generating the different prompts generates the different prompts for each of the plurality of operation processes such that the different instruction statements corresponding to each of the plurality of operation processes is included according to the different instruction statements.

16. The method of claim 14, further comprising:
determining, by each of the plurality of defect determination models, whether an operation process corresponding to the respective defect determination model among the plurality of operation processes is defective by using an output of the large language model.

17. The method of claim 14, wherein the generating the different prompts generates prompts for each of the plurality of operation processes such that data for each of the plurality of operation processes is included among the user query, the answer, the respective log data, and the data corresponding to the search query.

18. A system for defect determination in a generative AI-based search system, the system comprising:
a memory and at least one processor,
wherein the memory and the processor are configured to:
collect a user query input to the generative AI-based search system,
collect an answer from the generative AI-based search system corresponding to the user query,
collect log data for each of a plurality of operation processes of the generative AI-based search system processed to output the answer to the user query,
determine whether each of the plurality of operation processes is defective based on at least one of the user query, the answer, or the respective log data, and
determine whether the generative AI-based search system is defective based on respective defect determination results for each of the plurality of operation processes.

19. A non-transitory computer-readable medium storing a program which, when executed by one or more processors in an electronic device, cause the one or more processors to perform a method comprising:
collecting a user query input to the generative AI-based search system;
collecting an answer from the generative AI-based search system corresponding to the user query;
collecting log data for each of a plurality of operation processes of the generative AI-based search system processed to output the answer to the user query;
determining whether each of the plurality of operation processes is defective based on at least one of the user query, the answer, or the respective log data; and
determining whether the generative AI-based search system is defective based on respective defect determination results for each of the plurality of operation processes.
